(19) United States
(12) Patent Application Publication
(10) Pub. No.: US 2016/0035456 A1
(43) Pub. Date: Feb. 4, 2016

(54) ELECTRICALLY CONDUCTIVE POLYMER COMPOSITIONS

(71) Applicant: VORBECK MATERIALS CORP., JESSUP, MD (US)

(72) Inventors: RAYMON J SAURO, COLUMBIA, MD (US); DAN F SCHEFFER, FREDERICK, MD (US)

(73) Assignee: VORBECK MATERIALS CORP., JESSUP, MD (US)

(21) Appl. No.: 14/812,582

(22) Filed: Jul. 29, 2015

Related U.S. Application Data
(60) Provisional application No. 62/031,143, filed on Jul. 30, 2014.

(51) Int. Cl. H01B 1/24

(52) U.S. Cl. CPC H01B 1/24

(57) ABSTRACT

Embodiments of the present invention relate to an electrically conductive composition and an article. The electrically conductive composition comprises a polymer, graphene sheets, and carbon black, wherein the ratio of the graphene sheets to carbon black is about 1:2 to about 1:20. An article comprising the electrically conductive composition.

### CROSS-REFERENCE TO RELATED APPLICATIONS

This application claims priority to U.S. Provisional Application No. 62/031,143 file Jul. 30, 2014. The application is hereby incorporated herein by reference.

### BACKGROUND

The present invention relates generally to polymer composites and specifically to conductive polymer composites. Articles manufactured from polymer compositions are used in many areas. In some cases, the use of a polymer composition may be limited by its electrical conductivity. In other cases, it may be useful or necessary to use polymer compositions that exhibit electrical conductivity but are more costly. At times, applications may require a polymer composite that is capable of meeting the combined demands of electrical conductivity and shielding performance in a durable polymer system.

### DETAILED DESCRIPTION

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Articles manufactured from polymer compositions are used in many areas. In some cases, the use of a polymer composition may be limited by its electrical conductivity. In other cases, it may be useful or necessary to utilize polymer compositions that have a desired electrical conductivity but may be more costly for particular applications. At times, applications may require polymer compositions that are capable of meeting the combined demands of electrical conductivity and shielding performance in a durable polymer system. As used herein, the term “about” can denote a range of ±0.5 of the given number.

Embodiments of the present invention seek to provide electrically conductive compositions (hereinafter “the compositions”). The compositions includes at least one polymer and graphene sheets (hereinafter “the graphene sheets”). The graphene sheets can be dispersed in the polymer matrix. The compositions can further include additional components (discussed further below). The compositions are at times compared herein to polymer systems having similar components (i.e. comprising the polymer(s) and other elements), except for the graphene sheets (hereinafter “unfilled compositions”).

The compositions can be formed into articles that require electrical conductivity. Applicable articles include, but are not limited to, electromagnetic shields, conductive gaskets, wire and cable coatings, static dissipative coverings, and conductors. The articles may be part of a larger apparatus. Some or all of the larger apparatus can exhibit electrical conductivity. The composition can be used for the passivation of surfaces, such as metal (e.g. steel, aluminum, etc.) surfaces, including exterior structures such as bridges and buildings. Examples of other uses of the composition includes: UV radiation resistant coatings, abrasion resistant coatings, coatings having permeation resistance to liquids (such as hydrocarbon, alcohols, water, etc.) and/or gases, electrically conductive coatings, static dissipative coatings, and blast and impact resistant coatings.

The composition can be used to make fabrics having electrical conductivity. The composition can be used in solar cell applications; solar energy capture applications; signage, flat panel displays; flexible displays, including light-emitting diode, organic light-emitting diode, and polymer light-emitting diode displays; backplanes and frontplanes for displays; and lighting, including electroluminescent and OLED lighting. The displays may be used as components of portable electronic devices, such as computers, cellular telephones, games, GPS receivers, personal digital assistants, music players, games, calculators, artificial “paper” and reading devices.

The composition may be used in packaging and/or to make labels. The composition may be used in inventory control and anti-counterfeiting applications (such as for pharmaceuticals), including package labels. The composition may be used to make smart packaging and labels (such as for marketing and advertisement, information gathering, inventory control, and information display). The composition may be used to form a Faraday cage in packaging, such as for electronic components. The composition can be used on electrical and electronic devices and components, such as housings, to provide EMI shielding properties. The composition may be used in micro-devices (such as microelectromechanical systems (MEMS) devices) including to provide antistatic coatings.

The composition may be used in the manufacture of housings, antennas, and other components of portable electronic devices, such as computers, cellular telephones, games, navigation systems, personal digital assistants, music players, games, calculators, radios, artificial “paper” and reading devices. The composition can be used to form thermally conductive channels on substrates or to form membranes having desired flow properties and porosities. Such materials could have highly variable and tunable porosities and porosity gradients can be formed. The composition can be used to form articles having anisotropic thermal and/or electrical conductivities. The composition can be used to form three-dimensional printed prototypes.

The composition can be used to make printed electronic devices (also referred to as “printed electronics) that may be in the form of complete devices, parts or sub elements of devices, electronic components. Printed electronics may be prepared by applying the composition to the substrate in a pattern comprising an electrically conductive pathway designed to achieve the desired electronic device. The pathway may be solid, mostly solid, in a liquid or gel form. The printed electronic devices may take on a wide variety of forms and be used in a large array of applications. They may contain multiple layers of electronic components (e.g. circuits) and/or substrates.

All or part of the printed layer(s) may be covered or coated with another material such as a cover coat, varnish, cover layer, cover films, dielectric coatings, electrolytes and other electrically conductive materials. There may also be one or more materials between the substrate and printed circuits. Layers may include semiconductors, metal foils, and dielectric materials. The printed electronics may further comprise additional components, such as processors, memory chips, other microchips, batteries, resistors, diodes, capacitors, and/or transistors. Other applications that are applicable to the composition include, but are not limited to: passive and active devices and components; electrical and electronic circuitry, integrated circuits; flexible printed circuit boards; transistors; field-effect transistors; microelectromechanical systems (MEMS) devices; microwave circuits; antennas; diffraction gratings; indicators; chipless tags (e.g. for theft deterrence from stores, libraries, etc.); security and theft deterrence devices for retail, library, and other settings; key pads; smart cards; sensors (including gas and biosensors); liquid crystalline displays (LCDs); signage; lighting; flat panel displays; flexible displays, including light-emitting diode, organic light-emitting diode, and polymer light-emitting diode displays; backplanes and frontplanes for displays; electroluminescent and OLED lighting; photovoltaic devices, including backplanes; product identifying chips and devices; membrane switches, batteries, including thin film batteries; electrodes; indicators; printed circuits in portable electronic devices (for example, cellular telephones, computers, personal digital assistants, global positioning system devices, music players, games, calculators, etc.); electronic connections made through hinges or other movable/bendable junctions in electronic devices such as cellular telephones, portable computers, folding keyboards, etc.); wearable electronics; and circuits in vehicles, medical devices, diagnostic devices, instruments.

As used herein, the term “use” refers to the use of the article in practical manner. The mere act of performing analytical/laboratory testing of conductive properties of the composition or articles that are derived therefrom is not considered to be a use, for example.

The composition can exhibit electrical conductive properties. In some embodiments, the surface resistivity of the composition may be no greater than about 10000 Ω/square/mil, or no greater than about 5000 Ω/square/mil, or no greater than about 1000 Ω/square/mil or no greater than about 700 Ω/square/mil, or no greater than about 500 Ω/square/mil, or no greater than about 350 Ω/square/mil, or no greater than about 200 Ω/square/mil, or no greater than about 200 Ω/square/mil, or no greater than about 150 Ω/square/mil, or no greater than about 100 Ω/square/mil, or no greater than about 75 Ω/square/mil, or no greater than about 50 Ω/square/mil, or no greater than about 30 Ω/square/mil, or no greater than about 20 Ω/square/mil, or no greater than about 10 Ω/square/mil, or no greater than about 5 Ω/square/mil, or no greater than about 1 Ω/square/mil, or no greater than about 0.1 Ω/square/mil, or no greater than about 0.01 Ω/square/mil, or no greater than about 0.001 Ω/square/mil.

The composition can include a ratio by weight of graphene sheets to conductive carbon of 1:2 to 1:20, 1:3 to 1:19, 1:4 to 1:18, 1:5 to 1:17, 1:6 to 1:16, 1:7 to 1:15, 1:8 to 1:14, 1:9 to 1:13, 1:10 to 1:12, about 1:3 to about 1:15, about 1:4 to about 1:20, about 1:10 to about 1:20, about 1:5 to about 1:10, about 1:8 to about 1:16, about 1:7 to about 1:14, about 1:6 to about 1:12. In certain embodiments, the composition exhibits a reduced surface resistance of at least 10-100× compared to unfilled compositions. The reduced surface resistance is at least partly contributable to the ratio by weight of graphene sheets to conductive carbon. The ratio by weight of graphene sheets to conductive carbon is critical in allowing the graphene sheets to form a continuous path in three-dimensions in the composition with close contact between the sheets.

Applicable polymers include, but are not limited to, thermosets, thermoplastics, non-melt processible polymers, rubbers, elastomers, thermoplastic elastomers, polymer alloys, and copolymers. As used herein, the term “copolymers” refers to polymers derived from two or more monomers. The polymers can be crosslinked, vulcanized, or otherwise cured.

The polymers include polyolefins, such as polyethylene, low density polyethylene (LDPE), linear low density polyethylene (LLDPE), high density polyethylene, ultrahigh molecular weight polyethylene, polypropylene, olefin polymers and copolymers, ethylene/propylene copolymers (EPR), ethylene/propylene/diene monomer copolymers (EPDM); olefin and styrene copolymers; polystyrene (including high impact polystyrene); styrene/butadiene rubbers (SBR); styrene/ethylene/butadiene/styrene copolymers (SEBS); isobutylene/maleic anhydride copolymers; ethylene/acrylic acid copolymers; acrylonitrile/butadiene/styrene copolymers (ABS); styrene/acrylonitrile polymers (SAN); styrene/maleic anhydride copolymers; poly(acrylonitrile); polyethylene/acrylonitrile butadiene styrene (PE/ABS), poly(vinyl pyrrolidone) and poly(vinyl pyrrolidone) copolymers; vinyl acetate/vinyl pyrrolidone copolymers; poly(vinyl acetate); poly(vinyl acetate) copolymers; ethylene/vinyl acetate copolymers (EVA); poly(vinyl alcohols) (PVOH); ethylene/vinyl alcohol copolymers (EVOH); poly(vinyl butyral) (PVB); poly(vinyl formal), polycarbonates (PC); polycarbonate/acrylonitrile butadiene styrene copolymers (PC/ABS); polyamides; polyesters; liquid crystalline polymers (LCPs); poly(lactic acid) (PLA); poly(phenylene oxide) (PPO); PPO-polyamide alloys; polysulphones (PSU); polysulfides; poly(phenylene sulfide); polyetherketone (PEK); polyetheretherketone (PEEK); cross-linked polyetheretherketone (XPEEK); polyimides; polyoxymethylene (POM) homo- and copolymers (also called polyacetals); polyetherimides; polyphenylene (self-reinforced polyphenylene (SRP); polybenimidazole (PBI), aramides (such as Kevlar® and Nomex®); polyureas; alkyds; cellulosic polymers (such as nitrocellulose, ethyl cellulose, ethyl hydroxyethyl cellulose, carboxymethyl cellulose, cellulose acetate, cellulose acetate propionates, and cellulose acetate butyrates); polyethers (such as poly(ethylene oxide), poly(propylene oxide), poly(propylene glycol), oxide/propylene oxide copolymers, etc.); alkyds; acrylic latex polymers; polyester acrylate oligomers and polymers; polyester diol diacrylate polymers; phenolic resins; melamine formaldehyde resins; urea formaldehyde resins; novolacs; poly(vinyl chloride); poly(vinylidene chloride); fluoropolymers (such as polytetrafluoroethylene (PTFE), fluorinated ethylene propylene polymers (FEP), poly(vinyl fluoride), poly(vinylidene fluoride), vinylidene fluoride/hexafluoropropylene copolymers (VF2/HFP), vinylidene fluoride/hexafluoropropylene/tetrafluoroethylene (VF2/HFP/TFE) copolymers, vinylidene fluoride)/vinyl methyl ether/tetrafluoroethylene (VF2/PVME/TFE) copolymers, vinylidene fluoride/hexafluoropropylene/tetrafluoroethylene copolymers (VF2/HPF/TFE), vinylidene fluoride/tetrafluoroethylene/propylene (VF2/TFE/P) copolymers, perfluoroelastomers such as tetrafluoroethylene perfluoroelastomers (FFKM), highly fluorinated elastomers (FEPM), perfluoro(alkyl vinyl ethers), perfluoro(methyl vinyl ether) (PMVE), perfluoro(ethyl vinyl ether) (PEVE), perfluoro(propyl vinyl ether) (PPVE), fluoropolymers having one or more repeat units derived from vinylidene fluoride, hexafluoropropylene, tetrafluoroethylene, chlorotrifluoroethylene (CTFE), perfluoro(alkyl vinyl ethers), etc.); polysiloxanes (e.g., (polydimethylenesiloxane, dimethylsiloxane/vinylmethylsiloxane copolymers, vinyldimethylsiloxane terminated poly(dimethylsiloxane), etc.); and polyurethanes (thermoplastic and thermosetting (including crosslinked polyurethanes such as those crosslinked amines, etc.); epoxy polymers (including crosslinked epoxy polymers such as those crosslinked with polysulfones, amines, etc.); acrylate polymers (such as poly(methyl methacrylate), acrylate polymers and copolymers, methyl methacrylate polymers, methacrylate copolymers, polymers derived from one or more acrylates, methacrylates, ethyl acrylates, ethyl methacrylates, butyl acrylates, butyl methacrylates, glycidyl acrylates and methacrylates, etc.).

Examples of applicable polyamides include, but are not limited to, aliphatic polyamides (such as polyamide 4,6; polyamide 6,6; polyamide 6; polyamide 11; polyamide 12; polyamide 6,9; polyamide 6,10; polyamide 6,12; polyamide 10,10; polyamide 10,12; and polyamide 12,12), alicyclic polyamides, and aromatic polyamides (such as poly(m-xylylene adipamide) (polyamide MXD,6)) and polyterephthalamides such as poly(dodecamethylene terephthalamide) (polyamide 12,T), poly(decamethylene terephthalamide) (polyamide 10,T), poly(nonamethylene terephthalamide) (polyamide 9,T), the polyamide of hexamethylene terephthalamide and hexamethylene adipamide, and the polyamide of hexamethyleneterephthalamide, and 2-methylpentamethyleneterephthalamide).

Examples of applicable acrylate polymers include, but are not limited to, acrylate polymers made by the polymerization of one or more acrylic acids (including acrylic acid, methacrylic acid, etc.) and their derivatives, such as esters. Examples also include methyl acrylate polymers, methyl methacrylate polymers, and methacrylate copolymers. Examples further include polymers derived from one or more acrylates, methacrylates, acrylic acid, methacrylic acid, methyl acrylate, methyl methacrylate, ethyl acrylate, ethyl methacrylate, butyl acrylate, butyl methacrylate, glycidyl acrylate, glycidyl methacrylates, 2-ethylhexyl acrylate, 2-ethylhexyl methacrylate, hydroxyethyl acrylate, hydroxyethyl (meth)acrylate, acrylonitrile, and the like. The polymers can comprise repeat units derived from other monomers such as olefins (e.g. ethylene, propylene, etc.), vinyl acetates, vinyl alcohols, vinyl pyrrolidones, etc. The polymers can include partially neutralized acrylate polymers and copolymers, such as ionomer resins.

Applicable of polyesters include, but are not limited to, poly(butylene terephthalate) (PBT), poly(ethylene terephthalate) (PET), poly(1,3-propylene terephthalate) (PPT), poly(ethylene naphthalate) (PEN), poly(cyclohexanedimethanol terephthalate) (PCT)), etc.

Applicable rubbers and elastomers include, but are not limited to, styrene/butadiene copolymers (SBR), styrene/ethylene/butadiene/styrene copolymer (SEBS), polyisoprene, ethylene/propylene copolymers (EPR), ethylene/propylene/monomer copolymers (EPM), ethylene/propylene/diene monomer copolymers (EPDM), chlorosulphonated polyethylene (CSM), chlorinated polyethylene (CM), ethylene/vinyl acetate copolymers (EVM), butyl rubber, natural rubber, polybutadiene (Buna CB), chloroprene rubber (CR), halogenated butyl rubber, bromobutyl rubber, chlorobutyl rubber, nitrile rubber (butadiene/acrylonitrile copolymer) (NBR) (Buna N rubber), hydrogenated nitrile rubber (FINER), carboxylated high-acrylonitrile butadiene rubbers (XNBR), carboxylated HNBR, epichlorohydrin copolymers (ECO), epichlorohydrin terpolymers (GECO), polyacrylic rubber (ACM, ABR), ethylene/acrylate rubber (AEM), polynorbornenes, polysulfide rubbers (e.g. OT and EOT), copolyetheresters, ionomers, polyurethanes, polyether urethanes, polyester urethanes, silicone rubbers and elastomers (such as polysiloxanes (e.g., (polydimethylenesiloxane, dimethylsiloxane/vinylmethylsiloxane copolymers, vinyldimethylsiloxane terminated poly(dimethylsiloxane), and similar material), fluorosilicone rubber, fluoromethyl silicone rubber (FMQ), fluorovinyl silicone rubbers (FVMQ), phenylmethyl silicone rubbers (PMQ), vinyl silicone rubbers, and similar material), fluoropolymers (such as perfluorocarbon rubbers (FFKM), fluoronated hydrocarbon rubbers (FKM), fluorinated ethylene propylene polymers (FEP), poly(vinyl fluoride), poly(vinylidene fluoride), vinylidene fluoride/hexafluoropropylene copolymers (VF2/HFP), vinylidene fluoride/hexafluoropropylene/tetrafluoroethylene (VF2/HFP/TFE) copolymers, vinylidene fluoride)/vinyl methyl ether/tetrafluoroethylene (VF2/PVME/TFE) copolymers, vinylidene fluoride/hexafluoropropylene/tetrafluoroethylene copolymers (VF2/HPF/TFE), vinylidene fluoride/tetrafluoroethylene/propylene (VF2/TFE/P) copolymers, perfluoroelastomers such as tetrafluoroethylene perfluoroelastomers (FFKM), highly fluorinated elastomers (FEPM), perfluoro(alkyl vinyl ethers), perfluoro(methyl vinyl ether) (PMVE), perfluoro(ethyl vinyl ether) (PEVE), perfluoro(propyl vinyl ether) (PPVE), fluoropolymers having one or more repeat units derived from vinylidene fluoride, hexafluoropropylene, tetrafluoroethylene, chlorotrifluoroethylene (CTFE), perfluoro(alkyl vinyl ethers), and similar material), and as well as similar material.

Examples of applicable electrically conductive polymers include, but are not limited to, polyacetylene, polyethylene dioxythiophene (PEDOT), poly(styrenesulfonate) (PSS), PEDOT:PSS copolymers, polythiophene and polythiophenes, poly(3-alkylthiophenes), poly(2,5-bis (3-tetradecylthiophen-2-yl)thieno[3,2-b]thiophene) (PBTTT), poly(phenylenevinylene), polypyrene, polycarbazole, polyazulene, polyazepine, polyflurorenes, polynaphthalene, polyisonaphthalene, polyaniline, polypyrrole, poly(phenylene sulfide), polycarbozoles, polyindoles, polyphenylenes, copolymers of one or more of the foregoing, and their derivatives and copolymers. The conductive polymers may be undoped or doped, for example, with boron, phosphorous, and iodine.

The polymers, graphene sheets, and additional components, if used, can be formed into the compositions using any suitable means, including melt processing (using, for example, one or more of single or twin-screw extruders, blenders, kneaders, mixers, Brabender mixers, Banbury mixers, roller mills (such as two-roll mills, three-roll mill), and similar apparati), solution/dispersion processing/blending, via thermosetting lay-ups, and similar processes. At least a portion of the graphene sheets (and/or other components) can be added to monomer or oligomers that are then in-situ polymerized to form the polymers. The graphene sheets (and/or other components) can be added to a polymer matrix that is then cross-linked, vulcanized, or otherwise cured. The graphene sheets can be blended with rubbers and other elastomers in a mixer and the rubber or elastomer blends later crosslinked.

The graphene sheets can be added to the polymer as dry powder, in a solvent dispersion, suspension, or paste, or as combinations thereof

In other embodiments, a binder can be present relative to graphene sheets and graphite, when used, from 1 to 99 weight percent, or from 1 to 50 weight percent, or from 1 to 30 weight percent, or from 1 to 20 weight percent, or from 5 to 80 weight percent, or from 5 to 60 weight percent, or from 5 to 30 weight percent, or from 15 to 85 weight percent, or from 15 to 60 weight percent, or from 15 to 30 weight percent, or from 25 to 80 weight percent, or from 25 to 50 weight percent, or from 40 to 90 weight percent, or from 50 to 90 weight percent, or from 70 to 95 weight percent, based on the total weight of binder and graphene plus graphite, when present.

Articles can be formed from the compositions using any suitable method, including compression molding, extrusion, ram extrusion, injection molding, extrusion, co-extrusion, rotational molding, blow molding, injection blow molding, flexible molding, thermoforming, vacuum forming, casting, solution casting, centrifugal casting, overmolding, reaction injection molding, vacuum assisted resin transfer molding, spinning, printing, spraying, sputtering, coating, roll-to-roll processing, laminating, and/or similar processes. Thermoset composites that include the composition can be formed by mixing resin precursors with graphene sheets and, optionally, other additives in a mold and curing to form the article.

Examples of additional additives include, but are not limited to, accelerators, antioxidants, antiozonants, carbon black, calcium, clays, curing systems (e.g., peroxides (e.g., dicumyl peroxide), sulfur, initiators, etc.), crosslinkers, lubricants, mold-release agents, fatty acids (stearic acid), zinc oxide, silica, processing aids, blowing aids, adhesion promoters, plasticizers, dyes, pigments, reinforcing agents and fillers (glass fibers, carbon fibers, miners, etc.), heat stabilizers, UV stabilizers, flame retardants, metals, electrically and/or thermally conductive additives, etc.

The compositions can contain electrically conductive components, such as metals (including metal alloys), conductive metal oxides, conductive carbons, polymers, metal-coated materials, and similar materials. These components can take a variety of forms, including, but not limited to, particles, powders, flakes, foils, and needles.

Applicable metals include, but are not limited to, zinc, aluminum, nickel, silver, copper, tin, iron, gold, brass, bronze, platinum, palladium, lead, steel, rhodium, titanium, tungsten, magnesium, colloidal metals, and similar materials.

Applicable metal oxides, include, but are not limited to, antimony tin oxide and indium tin oxide and materials such as fillers coated with metal oxides. Metal and metal-oxide coated materials include, but are not limited to, metal coated carbon and graphite fibers, metal coated glass fibers, metal coated glass beads, metal coated ceramic materials (such as beads), and similar materials. These materials can be coated with a variety of metals, including nickel.

Applicable conductive carbons include, but are not limited to, graphite (including natural, Kish, and synthetic, annealed, pyrolytic, highly oriented pyrolytic, and similar graphites), graphitized carbon, carbon fibers and fibrils, carbon whiskers, vapor-grown carbon nanofibers, metal coated carbon fibers, carbon nanotubes (including single- and multi-walled nanotubes), fullerenes, activated carbon, carbon fibers, expanded graphite, expandable graphite, graphite oxide, hollow carbon spheres, carbon foams, and similar elements. Applicable carbon black material includes conductive carbon black material that may be of a very high purity.

The carbon black material may be soft pellets and/or powder. Applicable carbon black materials include, but are not limited to, Ketjen EC-600®, Emperor® 1600, 1200, and 1800, Ensaco 250G, 350G, 260G, as well as various American Society for Testing and Materials (ASTM) grade (such as N110, N115, N120, N121, N125, N134, N135, S212, N220, N231, N234, N239, N299, S315, N326, N330, N335, N339, N343, N347, N351, N356, N358, N357, N539, N550, N582, N630, N642, N650, N660, N683, N754, N762, N765, N772N774, N787, N907, N908, N990, and N991).

Applicable thermally conductive additives include, but are not limited to, metal oxides, nitrides, ceramics, minerals, silicates, etc. Examples include boron nitride, aluminum nitride, alumina, aluminum nitride, berylium oxide, nickel oxide, titanium dioxide, copper(I) oxide, copper (II) oxide, iron(II) oxide, iron(I,II) oxide (magnetite), iron (III) oxide, silicon dioxide, zinc oxide, magnesium oxide (MgO), and similar compounds.

Examples of curing and crosslinking agents include, but are not limited to, radical initiators such as radical polymerization initiators, radical sources, etc., including organic and inorganic compounds. Coagents and crosslinking promoters may be used as well. Examples include organic and inorganic peroxides (such as hydrogen peroxide, dialkyl peroxides, hydroperoxides, peracids, diacyl peroxides, peroxy esters, ketone peroxides, hydrocarbon peroxides, organometallic peroxides, organic polyoxides, organic polyoxides, dialkyl trioxides, hydrotrioxides, tetroxides, alkali metal peroxides (such as lithium peroxide), etc.), azo compounds, polyphenylhydrocarbons, substituted hydrazines, alkoxyamines, nitrocompounds, nitrates, nitrites, nitroxides, disulfides, polysulfides, persulfates (e.g. potassium persulfate, etc.), and similar compounds.

Examples of peroxides include, but are not limited to dibenzoyl peroxide, dicumyl peroxide, acetone peroxide, methyl ethyl ketone peroxide, lauroyl peroxide, tert-butyl peroxide, tert-butyl peracetate, di-tert-amyl peroxide, tert-butyl hydroperoxide, cumene hydroperoxide, 1,3-bis-(tent-butylperoxy-1-propyl) benzene, bis-(tert-butylperoxy) valerate, bis-(2,4-dichlorobenzoyl) peroxide, and similar compounds.

Examples of azo compounds include azobisisobutylonitrile (AIBN); 1,1′-azobis (cyclohexanecarbonitrile) (ABCN); 2,2′-azobis(2-methylbutyronitrile); 2,2′-azobis(2-methylpropionitrile); 2,2′-azobis(2-methylpropionitrile); N-tert-butyl-N-(2-methyl-1-phenylpropyl)-O-(1-phenylethyl) hydroxylamine, and similar compounds.

Turning now to the graphene sheets, these components can have a surface area of from about 100 to about 2630 m²/g. In some embodiments, the graphene sheets also comprise fully exfoliated single sheets of graphite (these are approximately ≦1 nm thick and are often referred to as “graphene”), while in other embodiments, the graphene sheets may also comprise partially exfoliated graphite sheets, in which two or more sheets of graphite have not been exfoliated from each other. The graphene sheets may comprise mixtures of fully and partially exfoliated graphite sheets. The graphene sheets are distinct from carbon nanotubes and have a “platey” (e.g. two-dimensional) structure that does not resemble the needle-like form of carbon nanotubes. The two longest dimensions of the graphene sheets may each be at least 10 times greater, or at least 50 times greater, or at least 100 times greater, or at least 1000 times greater, or at least 5000 times greater, or at least 10,000 times greater than the shortest dimension (i.e. thickness) of the sheets.

The graphene sheets may be obtained from, for example, graphite, graphite oxide, expandable graphite, expanded graphite. The graphene sheets may be obtained by the physical exfoliation of graphite by, for example, peeling, grinding, or milling off graphene sheets. The graphene sheets may be made from inorganic precursors, such as silicon carbide. The graphene sheets may be made by chemical vapor deposition, such as by reacting a methane and hydrogen on a metal surface.

The graphene sheets may be derived from the reduction of an alcohol, such ethanol, with a metal (such as an alkali metal like sodium) and the subsequent pyrolysis of the alkoxide product, such as disclosed in Nature Nanotechnology (2009), 4, 30-33, herein incorporated by reference. The graphene sheets may be derived from the exfoliation of graphite in dispersions or exfoliation of graphite oxide in dispersions and the subsequently reducing the exfoliated graphite oxide. The graphene sheets may be derived from the exfoliation of expandable graphite, followed by intercalation, and ultrasonication or other means of separating the intercalated sheets as described in Nature Nanotechnology (2008), 3, 538-542, herein incorporated by reference. The graphene sheets may be derived from the intercalation of graphite and the subsequent exfoliation of the product in suspension or thermally.

The graphene sheets may be derived from graphite oxide (also known as graphitic acid or graphene oxide). For example, graphite may be treated with oxidizing and/or intercalating agents and exfoliated. The graphite may also be treated with intercalating agents and electrochemically oxidized and exfoliated. The graphene sheets may be derived by ultrasonically exfoliating suspensions of graphite and/or graphite oxide in a liquid (which may contain surfactants and/or intercalants). Exfoliated graphite oxide dispersions or suspensions can be subsequently reduced to graphene sheets. The graphene sheets may also be derived by mechanical treatment, such as grinding or milling, to exfoliate graphite or graphite oxide, which may subsequently be reduced to graphene sheets.

Reduction of graphite oxide to graphene may be accomplished by means of a chemical reduction, which may be carried out on graphite oxide in a dry form or in a dispersion. Examples of useful chemical reducing agents include, but are not limited to, hydrazines, such as hydrazine, N,N-dimethylhydrazine, sodium borohydride, citric acid, hydroquinone, isocyanates, such as phenyl isocyanate, hydrogen, and hydrogen plasma. A dispersion or suspension of exfoliated graphite oxide in a carrier, such as water, organic solvents, or a mixture of solvents, can be prepared using any suitable method, such as ultrasonication and/or mechanical grinding or milling, and reduced to graphene sheets, in accordance with an embodiment of the present invention.

Graphite oxide may be produced by any method known in the art, in accordance with an embodiment of the present invention. For example, graphite oxide can result from the oxidation of graphite using one or more chemical oxidizing agents and, optionally, intercalating agents such as sulfuric acid. Examples of applicable oxidizing agents include, but are not limited to, nitric acid, nitrates, such as sodium and potassium nitrates, perchlorates, potassium chlorate, sodium chlorate, chromic acid, potassium chromate, sodium chromate, potassium dichromate, sodium dichromate, hydrogen peroxide, sodium and potassium permanganates, phosphoric acid (H₃PO₄), phosphorus pentoxide, and bisulfites. Applicable oxidants include, but are not limited to, KClO₄; HNO₃ and KClO₃; KMnO₄ and/or NaMnO₄; KMnO₄ and NaNO₃; K₂S₂O₈ and P₂O₅ and KMnO₄; KMnO₄ and HNO₃; and HNO₃. Applicable intercalation agents include sulfuric acid. Graphite may also be treated with intercalating agents and electrochemically oxidized to produce graphite oxide. Examples of applicable methods of making graphite oxide are also described by Staudenmaier (Ber. Stsch. Chem. Ges. (1898), 31, 1481) and Hummers (J. Am. Chem. Soc. (1958), 80, 1339), which are both herein incorporated by reference.

An example of a method for the preparation of graphene sheets involves the oxidation of graphite to graphite oxide, and subsequent thermal exfoliation, as described in US 2007/0092432, which is hereby incorporated by reference. The resulting graphene sheets typically display little or no signature corresponding to graphite or graphite oxide in their X-ray diffraction pattern. The thermal exfoliation may be carried out in a continuous or semi-continuous batch process.

The thermal exfoliation heating can be accomplished in a batch process or a continuous process and can be done under a variety of atmospheres, including inert and reducing atmospheres, such as nitrogen, argon, and/or hydrogen atmospheres. Required heating times can range from under a few seconds or several hours or more, depending on the temperatures used and the characteristics desired in the final thermally exfoliated graphite oxide. The heating can be undertaking in any appropriate vessel, such as a fused silica, mineral, metal, carbon, such as graphite, or ceramic vessel. The heating may be accomplished using a flash lamp or with microwaves. For example, during heating, the graphite oxide may be contained in an essentially constant location in single batch reaction vessel, or may be transported through one or more vessels during the reaction in a continuous or batch mode. The heating may be accomplished using any suitable means, including the use of furnaces and infrared heaters, in accordance with an embodiment of the present invention.

Examples of temperatures at which the thermal exfoliation and/or reduction of graphite oxide can be carried out can be at least 150° C., at least 200° C., at least 300° C., at least 400° C., at least 450° C., at least 500° C., at least 600° C., at least 700° C., at least 750° C., at least 800° C., at least 850° C., at least 900° C., at least 950° C., at least 1000° C., at least 1100° C., at least 1500° C., at least 2000° C., and at least 2500° C. Applicable temperature ranges required for the thermal exfoliation and/or reduction include between 750 and 3000° C., between 850 and 2500° C., between 950 and 2500° C., between 950 and 1500° C., between 750 about and 3100° C., between 850 and 2500° C., or between 950 and 2500° C.

The time of heating can range from less than a second to a plurality of minutes, for example, less than 0.5 seconds, less than 1 second, less than 5 seconds, less than 10 seconds, less than 20 seconds, less than 30 seconds, or less than 1 min. The time of heating can be at least 1 minute, at least 2 minutes, at least 5 minutes, at least 15 minutes, at least 30 minutes, at least 45 minutes, at least 60 minutes, at least 90 minutes, at least 120 minutes, at least 150 minutes, at least 240 minutes, from 0.01 seconds to 240 minutes, from 0.5 seconds to 240 minutes, from 1 second to 240 minutes, from 1 minute to 240 minutes, from 0.01 seconds to 60 minutes, from 0.5 seconds to 60 minutes, from 1 second to 60 minutes, from 1 minute to 60 minutes, from 0.01 seconds to 10 minutes, from 0.5 seconds to 10 minutes, from 1 second to 10 minutes, from 1 minute to 10 minutes, from 0.01 seconds to 1 minute, from 0.5 seconds to 1 minute, from 1 second to 1 minute, no more than 600 minutes, no more than 450 minutes, no more than 300 minutes, no more than 180 minutes, no more than 120 minutes, no more than 90 minutes, no more than 60 minutes, no more than 30 minutes, no more than 15 minutes, no more than 10 minutes, no more than 5 minutes, no more than 1 minute, no more than 30 seconds, no more than 10 seconds, or no more than 1 second. During the course of heating, the temperature may vary.

Examples of the rate of heating can include at least 120° C./min, at least 200° C./min, at least 300° C./min, at least 400° C./min, at least 600° C./min, at least 800° C./min, at least 1000° C/min, at least 1200° C./min, at least 1500° C./min, at least 1800° C./min, and at least 2000° C/min.

The graphene sheets may be annealed or reduced to graphene sheets having higher carbon to oxygen ratios by heating under reducing atmospheric conditions (e.g., in systems purged with inert gases or hydrogen). The reduction/annealing temperatures can be at least 300° C., or at least 350° C., or at least 400° C., or at least 500° C., or at least 600° C., or at least 750° C., or at least 850° C., or at least 950° C., or at least 1000° C. The reduction/annealing temperature used may be, for example, between about 750 about and 3000° C., or between about 850 and 2500° C., or between about 950 and about 2500° C.

The time of heating for the reduction/annealing can be for example, at least 1 second, or at least 10 second, or at least 1 minute, or at least 2 minutes, or at least 5 minutes. In some embodiments, the heating time for the reduction/annealing is at least 15 minutes, or 30 minutes, or 45 minutes, or 60 minutes, or 90 minutes, or 120 minutes, or 150 minutes. During the course of annealing/reduction, the temperature may vary within these ranges.

The heating may be done under a variety of conditions, including in an inert atmosphere, such as argon or nitrogen, or a reducing atmosphere, such as hydrogen, including, but not limited to, hydrogen diluted in an inert gas such as argon or nitrogen, or under vacuum. The heating may be done in any appropriate vessel, such as a fused silica or a mineral or ceramic vessel or a metal vessel. The heated materials, including any starting materials and any products or intermediates may be contained in an essentially constant location in single batch reaction vessel, or may be transported through one or more vessels during the reaction in a continuous or batch reaction. Heating may be done using any suitable means, including the use of furnaces and infrared heaters.

The graphene sheets can have a surface area of at least 100 m²/g to for example, at least 200 m²/g, at least 300 m²/g, at least 350 m²/g, at least 400 m²/g, at least 500 m²/g, at least 600 m²/g, at least 700 m²/g, at least 800 m²/g, at least 900 m²/g, or at least 700 m²/g. The surface area may be 400 to 1100 m²/g. The maximum surface area can be calculated to be 2630 m²/g. The surface area can include all values and subvalues therebetween, including, for example, 400, 500, 600, 700, 800, 900, 1000, 1100, 1200, 1300, 1400, 1500, 1600, 1700, 1800, 1900, 2000, 2100, 2200, 2300, 2400, 2500, and 2630 m²/g.

The graphene sheets can have number average aspect ratios of 100 to 100,000, 100 to 50,000, 100 to 25,000, and 100 to 10,000. The aspect ratio is the ratio of the longest dimension of the sheet to the shortest.

The graphene sheets may have a bulk density of 0.01 to at least 200 kg/m³. The bulk density can include all values and subvalues therebetween, including 0.05, 0.1, 0.5, 1, 5, 10, 15, 20, 25, 30, 35, 50, 75, 100, 125, 150, and 175 kg/m³.

The graphene sheets may be functionalized with, for example, oxygen-containing functional groups (including, but not limited to, hydroxyl, carboxyl, and epoxy groups) and typically have an overall carbon to oxygen molar ratio (hereinafter “C/O ratio”), as determined by bulk elemental analysis, of at least 1:1, or at least 3:2. Examples of applicable C/O ratio can include 3:2 to 85:15; 3:2 to 20:1; 3:2 to 30:1; 3:2 to 40:1; 3:2 to 60:1; 3:2 to 80:1; 3:2 to 100:1; 3:2 to 200:1; 3:2 to 500:1; 3:2 to 1000:1; 3:2 to greater than 1000:1; 10:1 to 30:1; 80:1 to 100:1; 20:1 to 100:1; 20:1 to 500:1; 20:1 to 1000:1; 50:1 to 300:1; 50:1 to 500:1; and 50:1 to 1000:1. In some embodiments, the C/O ratio is at least 10:1, or at least 15:1, or at least 20:1, or at least 35:1, or at least 50:1, or at least 75:1, or at least 100:1, or at least 200:1, or at least 300:1, or at least 400:1, or at least 500:1, or at least 750:1, or at least 1000:1; or at least 1500:1, or at least 2000:1. The C/O ratio also can include all values and subvalues between these ranges.

The graphene sheets may contain atomic scale kinks, which may be caused by the presence of lattice defects in, or by chemical functionalization of the two-dimensional hexagonal lattice structure of the graphite basal plane.

The composition may further comprise graphite, including, but not included to, natural, Kish, and synthetic, annealed, pyrolytic, and highly oriented pyrolytic graphites. The ratio by weight of graphite to graphene sheets may be from 2:98 to 98:2, or from 5:95 to 95:5, or from 10:90 to 90:10, or from 20:80 to 80:20, or from 30:70 to 70:30, or from 40:60 to 90:10, or from 50:50 to 85:15, or from 60:40 to 85:15, or from 70:30 to 85:15.

The graphene sheets may comprise two or more graphene powders having different particle size distributions and/or morphologies. The graphite may also comprise two or more graphite powders having different particle size distributions and/or morphologies.

The graphene sheets, and optionally, additional components can be combined with polymers to make composites, including, but not limited to, polymer composites. The graphene sheets and, optionally, additional components can be dispersed in one or more solvents with or without a polymer binder.

Applicable solvents into which the graphene sheets can be dispersed include, but are not limited to, water, distilled or synthetic isoparaffinic hydrocarbons, such as Isopar® and Norpar® and Dowanol®, citrus terpenes and mixtures containing citrus terpenes, such as Purogen®, Electron, and Positron, terpenes and terpene alcohols (including terpineols, including alpha-terpineol), limonene, aliphatic petroleum distillates, alcohols (such as methanol, ethanol, n-propanol, i-propanol, n-butanol, i-butanol, sec-butanol, tert-butanol, pentanols, i-amyl alcohol, hexanols, heptanols, octanols, diacetone alcohol, butyl glycol, etc.), ketones (such as acetone, methyl ethyl ketone, cyclohexanone, i-butyl ketone, 2,6,8,trimethyl-4-nonanone etc.), esters (such as methyl acetate, ethyl acetate, n-propyl acetate, i-propyl acetate, n-butyl acetate, i-butyl acetate, tert-butyl acetate, carbitol acetate), glycol ethers, ester and alcohols (such as 2-(2-ethoxyethoxy) ethanol, propylene glycol monomethyl ether and other propylene glycol ethers; ethylene glycol monobutyl ether, 2-methoxyethyl ether (diglyme), propylene glycol methyl ether (PGME); and other ethylene glycol ethers; ethylene and propylene glycol ether acetates, diethylene glycol monoethyl ether acetate, 1-methoxy-2-propanol acetate (PGMEA); and hexylene glycol, such as Hexasol™, dibasic esters (such as dimethyl succinate, dimethyl glutarate, dimethyl adipate), dimethylsulfoxide (DMSO), 1,3-dimethyl-3,4,5,6-tetrahydro-2(1H)-pyrimidinone (DMPU), imides, amides (such as dimethylformamide (DMF) and dimethylacetamide), cyclic amides (such as N-methylpyrrolidone and 2-pyrrolidone), lactones (such as beta-propiolactone, gamma-valerolactone, delta-valerolactone, gamma-butyrolactone, epsilon-caprolactone), cyclic imides (such as imidazolidinones such as N,N′-dimethylimidazolidinone (1,3-dimethyl-2-imidazolidinone)), aromatic solvents and aromatic solvent mixtures (such as toluene, xylenes, mesitylene, and cumene), petroleum distillates, naphthas (such as VM&P naphtha), and mixtures of two or more of the foregoing and mixtures of one or more of the foregoing with other carriers. Solvents can be, for example, low- or non-VOC solvents, non-hazardous air pollution solvents, and non-halogenated solvents.

The compositions can contain additives (discussed further below), such as dispersion aids (including, but not limited to, surfactants, emulsifiers, and wetting aids), adhesion promoters, thickening agents (including clays), defoamers and antifoamers, biocides, additional fillers, filler carbons, structural reinforcing carbon materials, flow enhancers, stabilizers, crosslinking and curing agents, as well as conductive additives.

Examples of applicable dispersing aids include glycol ethers (such as poly(ethylene oxide), block copolymers derived from ethylene oxide and propylene oxide, such Pluronic), acetylenic diols (such as 2,5,8,11-tetramethyl-6-dodecyn-5,8-diol ethoxylate and Surfynol® and Dynol , salts of carboxylic acids (including alkali metal and ammonium salts), and polysiloxanes.

Examples of applicable grinding aids include stearates (such as Al, Ca, Mg, and Zn stearates) and acetylenic diols, such as Surfynol® and Dynol).

Examples of applicable adhesion promoters include titanium chelates and other titanium compounds such as titanium phosphate complexes (including butyl titanium phosphate), titanate esters, diisopropoxy titanium bis(ethyl-3-oxobutanoate, isopropoxy titanium acetylacetonate, and Vertec.

The compositions may optionally comprise at least one “multi-chain lipid”, by which term is meant a naturally-occurring or synthetic lipid having a polar head group and at least two nonpolar tail groups connected thereto. Examples of applicable polar head groups include, but are not limited to, oxygen-, sulfur-, and halogen-containing, phosphates, amides, ammonium groups, amino acids (including α-amino acids), saccharides, polysaccharides, esters (Including glyceryl esters), and zwitterionic groups.

The tail groups may be the same or different. Examples of applicable tail groups include, but are not limited to, alkanes, alkenes, alkynes, and aromatic compounds. The tail groups may be hydrocarbons, functionalized hydrocarbons. The tail groups may be saturated or unsaturated. The tail groups may be linear or branched. The tail groups may be derived from, for example, fatty acids, such as oleic acid, palmitic acid, stearic acid, arachidic acid, erucic acid, arachadonic acid, linoleic acid, linolenic acid, and oleic acid.

Examples of multi-chain lipids include, but are not limited to, lecithin and other phospholipids (such as phosphatidylcholine, phosphoglycerides (including phosphatidylserine, phosphatidylinositol, phosphatidylethanolamine (cephalin), and phosphatidylglycerol) and sphingomyelin); glycolipids (such as glucosyl-cerebroside); saccharolipids; and sphingolipids (such as ceramides, di- and triglycerides, phosphosphingolipids, and glycosphingolipids). The multi-chain lipids may be amphoteric, including zwitterionic.

Examples of thickening agents include, but are not limited to, glycol ethers (such as poly(ethylene oxide), block copolymers derived from ethylene oxide and propylene oxide (such as Pluronic®), long-chain carboxylate salts (such aluminum, calcium, zinc, etc. salts of stearates, oleats, and palmitates), aluminosilicates (such as Minex® and Aerosil® 9200), fumed silica, natural and synthetic zeolites.

For example, components of the composition, such as one or more of the graphene sheets, carbon black, binders, carriers, and/or other components can be processed (e.g., milled/ ground, blended by using suitable mixing, dispersing, and/or compounding techniques and apparatus, including ultrasonic devices, high-shear mixers, ball mills, attrition equipment, sandmills, two-roll mills, three-roll mills, cryogenic grinding crushers, extruders, kneaders, double planetary mixers, triple planetary mixers, high pressure homogenizers, horizontal and vertical wet grinding mills), accordance with an embodiment of the present invention. Applicable processing (including grinding) technologies can be wet or dry and can be continuous or discontinuous. Suitable materials for use as grinding media include, but are not limited to, metals, carbon steel, stainless steel, ceramics, stabilized ceramic media (such as cerium yttrium stabilized zirconium oxide), PTFE, glass, and tungsten carbide. The aforementioned methods can be used to change the particle size and/or morphology of the graphite, graphene sheets, other components, and blends or two or more components.

Components may be processed together or separately and may go through multiple processing (including mixing/blending) stages, each involving one or more components (including blends).

There are no particular limitations to the manner in which the graphene sheets, carbon black and other components may be processed and combined. For example, graphene sheets and/or carbon black may be processed into given particle size distributions and/or morphologies separately and then combined for further processing with or without the presence of additional components. Unprocessed graphene sheets and/or carbon black may be combined with processed graphene sheets and/or carbon black and further processed with or without the presence of additional components. Processed and/or unprocessed graphene sheets and/or processed and/or unprocessed carbon black may be combined with other components, such as one or more binders and then combined with processed and/or unprocessed graphene sheets and/or processed and/or unprocessed carbon black. Two or more combinations of processed and/or unprocessed graphene sheets and/or processed and/or unprocessed carbon black that have been combined with other components may be further combined or processed. Any of the foregoing processing steps can be done in the presence of at least one aromatic compound.

In one embodiment, if a multi-chain lipid is used, it can be added to graphene sheets (and/or graphite if present) before processing.

After blending and/or grinding steps, additional components may be added to the compositions, including, but not limited to, thickeners, viscosity modifiers, and binders. The compositions may also be diluted by the addition of more carrier.

The composition can be applied to a wide variety of applicable substrates, including, but not limited to, flexible and/or stretchable materials, silicones and other elastomers and other polymeric materials, metals (such as aluminum, copper, steel, stainless steel, etc.), adhesives, heat-sealable materials (such as cellulose, biaxially oriented polypropylene (BOPP), poly(lactic acid), polyurethanes, etc.), fabrics (including cloths) and textiles (such as cotton, wool, polyesters, rayon, etc.), clothing, ceramics, silicon surfaces, wood, paper, cardboard, paperboard, cellulose-based materials, glassine, labels, silicon, laminates, corrugated materials, concrete, and brick. The substrates can be in the form of films, papers, and larger three-dimensional objects.

The substrates may have been treated with other coatings (such as paints) or similar materials before the coatings are applied. Examples include, but are not limited to, substrates (such as PET) coated with indium tin oxide, and antimony tin oxide. The substrates may be woven, nonwoven, and in mesh form. The substrates may be woven, nonwoven, and in mesh form.

The substrates may be paper-based materials, including, but are not limited to, paper, paperboard, cardboard, and glassine. The paper-based materials can be surface treated. Examples of applicable surface treatments include, but are not limited to, coatings, such as polymeric coatings, which can include PET, polyethylene, polypropylene, acetates, and nitrocellulose. Coatings may be adhesives. The paper based materials may be sized.

Examples of applicable polymeric materials include, but are not limited to, those comprising thermoplastics and thermosets, including elastomers and rubbers (including thermoplastics and thermosets), silicones, fluorinated polysiloxanes, natural rubber, butyl rubber, chlorosulfonated polyethylene, chlorinated polyethylene, styrene/butadiene copolymers (SBR), styrene/ethylene/butadiene/stryene copolymers (SEBS), styrene/ethylene/butadiene/stryene copolymers grafted with maleic anhydride, styrene/isoprene/styrene copolymers (SIS), polyisoprene, nitrile rubbers, hydrogenated nitrile rubbers, neoprene, ethylene/propylene copolymers (EPR), ethylene/propylene/diene copolymers (EPDM), ethylene/vinyl acetate copolymer (EVA), hexafluoropropylene/vinylidene fluoride/tetrafluoroethylene copolymers, tetrafluoroethylene/propylene copolymers, fluorelastomers, polyesters (such as poly(ethylene terephthalate), poly(butylene terephthalate), poly(ethylene naphthalate), liquid crystalline polyesters, poly(lactic acid)).; polystyrene; polyamides (including polyterephthalamides); polyimides (such as Kapton®); aramids (such as Kevlar® and Nomex®); fluoropolymers (such as fluorinated ethylene propylene (FEP), polytetrafluoroethylene (PTFE), poly(vinyl fluoride), poly(vinylidene fluoride)); polyetherimides; poly(vinyl chloride); poly(vinylidene chloride); polyurethanes (such as thermoplastic polyurethanes (TPU); spandex, cellulosic polymers (such as nitrocellulose, cellulose acetate, etc.); styrene/acrylonitriles polymers (SAN); arcrylonitrile/butadiene/styrene polymers (ABS); polycarbonates; polyacrylates; poly(methyl methacrylate); ethylene/vinyl acetate copolymers; thermoset epoxies and polyurethanes; polyolefins (such as polyethylene (including low density polyethylene, high density polyethylene, ultrahigh molecular weight polyethylene, etc.), polypropylene (such as biaxially-oriented polypropylene, etc.); and Mylar. The polymeric materials may be non-woven materials, such as Tyvek®. The polymeric materials may be adhesive or adhesive-backed materials, such as adhesive-backed papers or paper substitutes. The polymeric materials may be mineral-based paper substitutes, such as Teslin . The substrate may be a transparent or translucent or optical material, such as glass, quartz, polymer (such as polycarbonate or poly(meth)acrylates (such as poly(methyl methacrylate).

The compositions may be applied to the substrate using any suitable method, including, but not limited to, painting, pouring, spin casting, solution casting, dip coating, powder coating, by syringe or pipette, spray coating, curtain coating, lamination, co-extrusion, electrospray deposition, ink jet printing, spin coating, thermal transfer (including laser transfer) methods, doctor blade printing, screen printing, rotary screen printing, gravure printing, lithographic printing, intaglio printing, digital printing, capillary printing, offset printing, electrohydrodynamic (EHD) printing (a method of which is described in WO 2007/053621,which is herein incorporated by reference), microprinting, pad printing, tampon printing, stencil printing, wire rod coating, drawing, flexographic printing, stamping, xerography, microcontact printing, dip pen nanolithography, laser printing, via pen or similar means, in accordance with an embodiment of the present invention. The compositions can be applied in multiple layers.

Subsequent to application to a substrate, the compositions may be cured using any suitable technique, including, but are not limited to, drying and oven-drying (in air or another inert or reactive atmosphere), UV curing, IR curing, drying, crosslinking, thermal curing, laser curing, IR curing, microwave curing or drying, and sintering, in accordance with an embodiment of the present invention.

The cured compositions can have a variety of thicknesses, for example, they can optionally have a thickness of at least 2 nm, or at least 5 nm. In various embodiments, the compositions can optionally have a thickness of 2 nm to 2 mm, 5 nm to 1 mm, 2 nm to 100 nm, 2 nm to 200 nm, 2 nm to 500 nm, 2 nm to 1 micrometer, 5 nm to 200 nm, 5 nm to 500 nm, 5 nm to 1 micrometer, 5 nm to 50 micrometers, 5 nm to 200 micrometers, 10 nm to 200 nm, 50 nm to 500 nm, 50 nm to 1 micrometer, 100 nm to 10 micrometers, 1 micrometer to 2 mm, 1 micrometer to 1 mm, 1 micrometer to 500 micrometers, 1 micrometer to 200 micrometers, 1 micrometer to 100 micrometers, 50 micrometers to 1 mm, 100 micrometers to 2 mm, 100 micrometers to 1 mm, 100 micrometers to 750 micrometers, 100 micrometers to 500 micrometers, 500 micrometers to 2 mm, or 500 micrometers to 1 mm.

For example, the total weight of the graphene sheets, carbon black, and polymer can be about 5 to about 70, about 10 to about 70, about 15 to about 70, about 20 to about 70, about 25 to about 70, about 35 to about 70, about 45 to about 70, about 55 to about 70, about 1 to about 55, about 5 to about 55, 10 to about 55, 15 to about 55, about 20 to about 55, about 25 to about 55,about 35 to about 55, about 45 to about 55, about 1 to about 45, about 5 to about 45, about 10 to about 45, about 15 to about 45, about 20 to about 45, about 25 to about 45, about 35 to about 45, about 1 to about 35, about 5 to about 35, about 10 to about 35, about 15 to about 35, about 20 to about 35, or about 25 to about 35.

The composition can comprise a ratio by weight of graphite, carbon black, and graphene sheets to polymer of about 2:98 to 98:2, about 5:95 to about 98:2, about 10:90 to about 98:2, about 20:80 to about 98:2, about 30:70 to about 98:2, 40:60 to about 98:2, about 50:50 to about 98:2, about 60:40 to about 98:2, about 70:30 to about 98:2, about 80:20 to about 98:2, about 90:10 to about 98:2, about 95:5 to about 98:2, 2:98 to 95:2, about 5:95 to about 95:2, about 10:90 to about 95:2, about 20:80 to about 95:2, about 30:70 to about 95:2, 40:60 to about 95:2, about 50:50 to about 95:2, about 60:40 to about 95:2, about 70:30 to about 95:2, about 80:20 to about 95:2, about 90:10 to about 95:2, about 95:5 to about 95:2, 2:98 to 90:10, about 5:95 to about 90:10, about 10:90 to about 90:10, about 20:80 to about 90:10, about 30:70 to about 90:10, 40:60 to about 90:10, about 50:50 to about 90:10, about 60:40 to about 90:10, about 70:30 to about 90:10, about 80:20 to about 90:10, about 90:10 to about 90:10, about 95:5 to about 90:10, 2:98 to 80:20, about 5:95 to about 80:20, about 10:90 to about 80:20, about 20:80 to about 80:20, about 30:70 to about 80:20, 40:60 to about 80:20, about 50:50 to about 80:20, about 60:40 to about 80:20, about 70:30 to about 80:20, about 80:20 to about 80:20, about 90:10 to about 80:20, about 95:5 to about 80:20, 2:98 to 70:30, about 5:95 to about 70:30, about 10:90 to about 70:30, about 20:80 to about 70:30, about 30:70 to about 70:30, 40:60 to about 70:30, about 50:50 to about 70:30, about 60:40 to about 70:30, about 70:30 to about 70:30, about 80:20 to about 70:30, about 90:10 to about 70:30, about 95:5 to about 70:30, 2:98 to 60:40, about 5:95 to about 60:40, about 10:90 to about 60:40, about 20:80 to about 60:40, about 30:70 to about 60:40, 40:60 to about 60:40, about 50:50 to about 60:40, about 60:40 to about 60:40, about 70:30 to about 60:40, about 80:20 to about 60:40, about 90:10 to about 60:40, about 95:5 to about 60:40, 2:98 to 50:50, about 5:95 to about 50:50, about 10:90 to about 50:50, about 20:80 to about 50:50, about 30:70 to about 50:50, 40:60 to about 50:50, about 50:50 to about 50:50, about 60:40 to about 50:50, about 70:30 to about 50:50, about 80:20 to about 50:50, about 90:10 to about 50:50, about 95:5 to about 50:50, 2:98 to 40:60, about 5:95 to about 40:60, about 10:90 to about 40:60, about 20:80 to about 40:60, about 30:70 to about 40:60, 40:60 to about 40:60, about 50:50 to about 40:60, about 60:40 to about 40:60, about 70:30 to about 40:60, about 80:20 to about 40:60, about 90:10 to about 40:60, about 95:5 to about 40:60, 2:98 to 30:70, about 5:95 to about 30:70, about 10:90 to about 30:70, about 20:80 to about 30:70, about 30:70 to about 30:70, 40:60 to about 30:70, about 50:50 to about 30:70, about 60:40 to about 30:70, about 70:30 to about 30:70, about 80:20 to about 30:70, about 90:10 to about 30:70, about 95:5 to about 30:70, 2:98 to 20:80, about 5:95 to about 20:80, about 10:90 to about 20:80, about 20:80 to about 20:80, about 30:70 to about 20:80, 40:60 to about 20:80, about 50:50 to about 20:80, about 60:40 to about 20:80, about 70:30 to about 20:80, about 80:20 to about 20:80, about 90:10 to about 20:80, about 95:5 to about 20:80, 2:98 to 10:90, about 5:95 to about 10:90, about 10:90 to about 10:90, about 20:80 to about 10:90, about 30:70 to about 10:90, 40:60 to about 10:90, about 50:50 to about 10:90, about 60:40 to about 10:90, about 70:30 to about 10:90, about 80:20 to about 10:90, about 90:10 to about 10:90, about 95:5 to about 10:90, 2:98 to 5:95, about 5:95 to about 5:95, about 10:90 to about 5:95, about 20:80 to about 5:95, about 30:70 to about 5:95, 40:60 to about 5:95, about 50:50 to about 5:95, about 60:40 to about 5:95, about 70:30 to about 5:95, about 80:20 to about 5:95, about 90:10 to about 5:95, about 95:5 to about 5:95.

Certain embodiments of the present invention relate to a composition and/or an article. The composition can comprise a polymer, graphene sheets, and carbon black, wherein the ratio by weight of the graphene sheets to carbon black can be about 1:2 to about 1:20. The ratio by weight of the graphene sheets to carbon black can be about 1:2 to about 1:10. The ratio by weight of the graphene sheets to carbon black can be about 1:3 to about 1:9. The graphene sheets can have a surface area of at least about 100 m²/g. The composition can have a ratio of the graphene sheets to the conductive carbon material of at least about 1:4. The polymer can include a thermoset. The polymer can be a rubber. The polymer can include a thermoplastic elastomer. The graphene sheets may present in the composition in about 1 to about 10, about 2 to about 9, about 3 to about 8, about 4 to about 7, or about 5 to about 6 parts per hundred rubber.

The composition may be stiffer compared to an unfilled composition. The polymer can comprise at least a rubber or a plastic. The composition can have a surface resistance of no than 40.0 Ω/square. The polymer can comprise styrene-butadiene-styrene, styrene-isoprene-styrene, styrene-isobutylene-styrene, polyurethane, polyester, a polyamide elastomer, a polyethylene-poly (-olefin) blend, a polypropylene/poly(ethylene-propylene) blend, a poly(etherimide)-polysiloxane blend, a polypropylene/hydrocarbon blend, a polypropylene/nitrile blend, a polyvinyl chloride-(nitrile+DOP) blend, a polyamide/silicon blend, polyester/silicon blend, and/or styrene-ethylene-butylene-styrene. The hydronated nitrile butadiene rubber can comprise a Zetpol® elastomer (distributed by ZEON Chemicals®), a Therban® elastomer (distributed by LANXESS AG), a chloroprene rubber, a polychloroprene polymer, a Neoprene® rubber (distributed by Dupont™), and/or a Baypren® rubber (distributed by LANXESS AG). The article can be comprised of the composition. The polymer can comprise a hydrogenated nitrile butadiene rubber. The composition can have a surface area of less than 50 Ω/square.

The composition can comprise about 1 to about 10 weight percent graphene sheets, based on the total weight of graphene sheets and polymer. The composition can comprise about 1 to about 70 weight percent of graphene sheets plus carbon black relative to the total weight of the graphene sheets, carbon black, and polymer. The article can comprise the composition.

What is claimed is:

1. An electrically conductive composition comprising: a polymer, graphene sheets, and carbon black, wherein the ratio by weight of the graphene sheets to carbon black is about 1:2 to about 1:20.

2. The electrically conductive composition of claim 1, wherein the graphene sheets have a ratio by weight of carbon black of about 1:2 to about 1:10.

3. The electrically conductive composition of claim 1, wherein the graphene sheets have a ratio by weight of carbon black of about 1:3 to about 1:9.

4. The electrically conductive composition of claim 1, wherein the graphene sheets have a surface area of at least about 100 m²/g.

5. The electrically conductive composition of claim 1, wherein the electrically conductive composition has a ratio by weight of the graphene sheets to the conductive carbon material of at least about 1:4.

6. The electrically conductive composition of claim 1, wherein the polymer includes a thermoset.

7. The electrically conductive composition of claim 1, wherein the polymer is a rubber.

8. The electrically conductive composition of claim 1, wherein the polymer includes a thermoplastic elastomer.

9. The electrically conductive composition of claim 7, wherein the graphene sheets are present in the composition in about 1 to about 10, about 2 to about 9, about 3 to about 8, about 4 to about 7, or about 5 to about 6 parts per hundred rubber.

10. The electrically conductive composition of claim 1, wherein the composition has a surface resistance of no more than 40.0 Ω/square.

11. The electrically conductive composition of claim 1, wherein the polymer comprises styrene-butadiene-styrene, styrene-isoprene-styrene, styrene-isobutylene-styrene, polyurethane, polyester, a polyamide elastomer, a polyethylene-poly(-olefin) blend, a polypropylene/poly(ethylene-propylene) blend, a poly(etherimide)-polysiloxane blend, a polypropylene/hydrocarbon blend, a polypropylene/nitrile blend, a polyvinyl chloride-(nitrile+DOP) blend, a polyamide/silicon blend, polyester/silicon blend, and/or styrene-ethylene-butylene-styrene.

12. The electrically conductive composition of claim 1, wherein the polymer is a hydrogenated nitrile butadiene rubber.

13. The electrically conductive composition of claim 1, wherein the electrically conductive composition has a surface resistance of less than 50 Ω/square.

14. The electrically conductive composition of claim 1, further comprises about 1 to about 10 weight percent graphene sheets, based on the total weight of the graphene sheets and the polymer.

15. The electrically conductive composition of claim 1, wherein the electrically conductive composition is stiffer compared to an unfilled electrically conductive composition that lacks the graphene sheets.

16. The electrically conductive composition of claim 1, wherein the polymer comprises at least a rubber or a plastic.

17. The electrically conductive composition of claim 1, wherein the hydronated nitrile butadiene rubber comprises a Zetpol® elastomer, a Therban® elastomer, a chloroprene rubber, a polychloroprene polymer, a Neoprene® rubber, and/or a Baypren® rubber.

18. An article comprising the electrically conductive composition of claim 1.

19. The article of claim 18, wherein the article is an electromagnetic shield, a conductive gasket, a wire covering, a cable covering, a static dissipative covering, or a conductor.

20. The article of claim 18, wherein the article is formed to a manner to passivate surfaces.
